(19) United States
(12) Patent Application Publication
(10) Pub. No.: US 2011/0246967 A1
(43) Pub. Date: Oct. 6, 2011

(54) METHODS AND SYSTEMS FOR AUTOMATION FRAMEWORK EXTENSIBILITY

(76) Inventor: Louis Thomas Garavaglia, JR., Felton, CA (US)

(21) Appl. No.: 13/075,180

(22) Filed: Mar. 30, 2011

Related U.S. Application Data
(60) Provisional application No. 61/341,435, filed on Mar. 30, 2010.

(51) Int. Cl. G06F 9/44

(52) U.S. Cl. 717/124

(57) ABSTRACT

A system and methods for providing an extensible automation framework for testing computer software are provided. Features include a framework application, a framework engine with multiple organizational levels, a subsumption engine, library modules, and global environment data. Functionality is subsumed directly from library modules into class objects allowing users to integrate new functionality directly into the automation framework without the need to create new classes. A subsumption engine extends a software language's native reference resolution mechanism with the ability to resolve references to static functions, static data, and other software entities as references to objects in the multiple organizational levels, both in the application module and in library modules. Subsumed functions extend the functionality of the subsuming instance object and gain access to all the functionality inherent in the subsuming class eliminating the need for elaborate interface mechanisms between test scripts and the test framework.

### CROSS-REFERENCE TO RELATED APPLICATIONS

This invention claims the benefit of U.S. Provisional Application Ser. No. 61/341,435 filed on Mar. 30, 2010, which is incorporated by reference herein in its entirety

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

This invention relates generally to a mechanism for creating test automation frameworks. In particular, the present invention relates to a simplified approach for extending an automation framework using externally defined functionality, providing a flexible organization of dynamically allocated framework levels, eliminating complex interface mechanisms between test scripts and the automation framework, increasing code reuse, and providing the ability to define uses cases that span the multiple organizational layers of the automation framework.

2. Description of the Related Art

In today's highly competitive world of high tech software engineering, there is the constant pressure to release new and improved products with ever increasing levels of complexity with less and less money. This drives the search for and adoption of ever more sophisticated tools to increase productivity and drive down costs.

As the complexity of the product increases, so must the complexity of the software used to configure, control and test these products. This is particularly evident in the early phases of development where the ultimate complexity of a product is not fully appreciated until project requirements collide with the reality of its implementation.

Testing is a particularly thorny problem. Most aspects of a project scale at the same rate. As a product increases in complexity, so too most supporting functionality. But testing scales much faster for two reasons. First, as more functionality is added, the new functionality must be tested and the existing functionality re-tested to ensure the new functionality has not broken existing functionality. Secondly, the matrix of possible testable features increases exponentially as new features are added. To get a handle on this problem development teams have traditionally looked to white box testing techniques driven by test automation as a way to reduce the resources needed ensure a product is adequately tested.

Typically test automation is accomplished using a test automation framework. A test automation framework is a collection of software and data configured to test a program unit by running it under varying conditions and monitoring its behavior and outputs. The conventional approach is to divide the automation framework into two parts: the test harness and the test script repository. The test harness provides the mechanism whereby testing is automated, whereby tests scripts are aggregated along functional lines, and whereby reports are generated. The test harness calls functions with supplied parameters, compares the actual output against expected output, reports on the results of that comparison, and provides an entity which can be driven by a test framework. Whether they target one specific testing modality like stress testing, load testing, regression testing, or attempt to serve in a broader context, the basic morphology of a test harness is the same. It provides a means to organize testing into a hierarchical arrangement of test functionality that mirrors the functionality of the device under test, provides a means to run scripts that test that functionality, a means to evaluate test output, and a means to report test results.

This approach is both a strength and weakness of the current state of the art. It is certainly strength to be able to create a set of tests that mirrors the functionality of the device under test and align these tests with the structure of a test harness. A problem arises though when testing is conceptualized in terms of use cases instead of device functionality. Device functionality is typically hierarchal in nature and is easily expressed in test cases. Use cases on the other hand, typically encompass more functionality than one normally associates with a single test case. Since the current state of the art typically equates test cases and use cases, test harnesses have evolved to deal with this problem by providing functionality invoked on entry into a test case that morphs the test case into a use case. The natural outcome of this is more complex interfaces and more complex test scripts resulting in fewer people understanding the test harness and the scripts it drives.

Another problem arises as the product under development evolves and changes, in that the maintenance and enhancement of the test framework becomes a substantial part of the test automation effort. To mitigate this problem, tools have evolved to provide a clear separation between the test harness and test scripts in an effort to isolate the test harness from the test scripts. Conventional tools present an abstraction layer which allows test scripts to interface to the many components in the test harness through a well defined interface layer. But a well defined interface limits a tool's functionality to that functionality defined by the interface. As more demands are made of the framework, the interface layer between the harness and the test scripts must be extended to accommodate the demands for then increased functionality. Over time, the automation tool becomes increasingly complex and difficult to deal with and more and more resources must be allocated to maintain the automation environment. Resources that could be used for testing specific use cases are spent maintaining the test environment. In this age of shorter and shorter development cycles, this frequently pushes business to do less and less automation.

In an effort to isolate the framework from the test scripts markup languages like XML are used to describe test cases to the test harness. Such an approach is used by tools like STAF/STAX, JCrawler, Pylot, and TestNG and others. But the flexibility this provides comes at a cost. Use cases must be translated into a series of test cases described using an arcane XML schema typically known only to a select few. Because of their special knowledge, these individuals become the focus of the development and bug fixing efforts associated with these automation environments often throttling the testing effort.

Another conventional approach is the keyword script approach as exemplified by Smart Bear's TestComplete where tests are described as a series of keyword actions and parameters. These tools are typically touted as requiring no programming skills because scripts are described as a series of tables. While there is no overt programming involved as such, the skills needed to create the tables are skills familiar to any programmer. The test must be abstracted in such a way that the test harness can process it and then described in tables that are themselves are a form of coding complete with variables, functions, and conditional logic

Tools that provide special purpose scripting languages form yet another conventional approach to solving this problem. These tools, Such as Hewlett Packard's Quick Test Pro, provide rich scripting languages with test specific extensions built into it. These tools provide a rich coding environment but tend to isolate test cases in their own execution environment with little ability to communicate through the under lying test harness to other test cases.

Tools like Fanfare's ITest attempt to overcome all these limitations by providing highly complex development environments that provide IDEs to translate various objects in the testing environment into abstract representations. These representations are saved in tables or scripts that can be fed to an underlying test harness at runtime to instantiate and drive the testing. While this approach can lead to a highly modularized automation framework, its complexity concentrates the domain knowledge of the test tool in the hands of just a few people. What's more, its multiple levels of indirection prevent data from flowing from child to parent objects limiting the way tests can be conceptualized and implemented.

Thus, there is a need for a flexible, easy-to-use framework providing a strong set of built-in functionality that allows automation engineers to rapidly implement complex product use cases without having to concern themselves with the restrictions imposed by the interfaces designed to isolate the test cases from the test harness.

### BRIEF SUMMARY OF THE INVENTION

The present invention enables systems and methods for providing an extensible automation framework with the ability to extend the core framework with additional organizational levels, each level having the ability to subsume externally defined software entities such as functions and data into the subsuming class as class methods and class data attributes is provided. This functionality is hereafter referred to as subsumption. Features include a framework application, framework engine encompassing a plurality of framework levels, a reference redirection engine, a subsumption engine, a metadata engine, a protocol engine and a plurality of library modules.

To obtain the benefits of working with a class-based object-oriented language, a system in accordance with the present invention is presented to the user as a framework class object which is instantiated to create an extensible framework engine class instance object. An extensible framework is created when the user instantiates the framework engine in the context of a framework application. The framework engine defines a plurality of levels, each with the ability to subsume external software entities. External software entities such as functions, data, and class definitions may be defined locally or in library modules. The framework engine facilitates importing and organizing this functionality into a hierarchical structure of framework levels whose class definitions are built into the framework engine. The order and manner in which framework levels are traversed and the subsumed functionality executed are under the control of the user within limits enforced by the framework levels.

To allow use cases definitions to span multiple levels within a framework, both vertically and horizontally, a system in accordance with the current invention implements a mechanism to store information in metadata. The metadata engine implements metadata as a set of environment variables that may be created at any level within the framework and whose value can be of any object type. They have varying degrees of scope that may be defined to span all levels in a framework application including frameworks applications spawned on remote hosts as well child processes spawned in sub-shells. Environment variables, hereafter known as evars, may have their scope changed, and carry with them information describing their usage and purpose.

### BRIEF DESCRIPTION OF THE SEVERAL VIEWS OF THE DRAWING

FIG. 1 illustrates a system for providing an extensible automation framework in accordance with an embodiment of the present invention.

FIG. 2 shows a detailed view of a framework application with integrated framework main and framework engine in accordance with an embodiment of the present invention.

FIG. 3 shows a detailed view of a framework engine in accordance with an embodiment of the present invention.

FIG. 4 shows a detailed view of a framework level in accordance with an embodiment of the present invention.

FIG. 5 shows a detailed view of a subsumption engine in accordance with an embodiment of the present invention.

FIG. 6 provides an operational flow of the subsumption process.

### DETAILED DESCRIPTION OF THE INVENTION

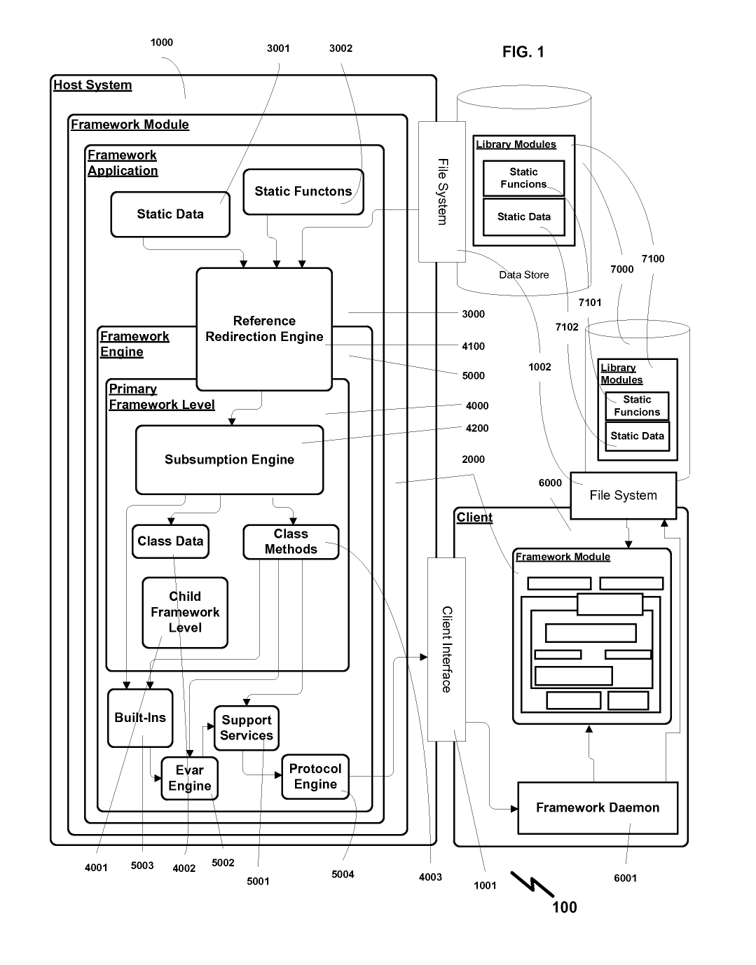

FIG. 1 illustrates a system 100 for providing an extensible automation framework in accordance with an embodiment of the present invention.

System 100 includes a host system 1000 and zero or more client processes 6000 connected to the host system 1000 through an application specific client interface 1001 which in one embodiment of the current invention is a local area network and a serial interface. Host system 1000 includes one or more framework modules 2000 which includes one or more framework applications 3000, zero or more static data 3001, zero or more static functions 3002 and zero or more framework engines 5000.

System 100 also include zero more module library modules 7100 which, in one embodiment of the current invention, are accessible through the local file system 1002 and imported into the framework engine 5000. Library modules 7100 include subsumable software entities including zero or more static data 7102 and zero or more static functions 7101. In one embodiment of the current invention they also include zero or more class definitions as subsumable objects.

Client interface 1001 provides system 100 with the ability to run multiple client processes 6000, locating them locally on the same system that contains framework module 2000 processes or remotely and distinct from each other. Note that a client process 6000 and the primary framework application 3000 are structurally the same and indeed may be the same module.

Framework application 3000 includes a framework engine 5000, and zero or more subsumable entities which may include zero or more static data 3001 and zero or more static functions 3002 in one embodiment.

Framework engine 5000 includes support functionality 5001, evar engine 5002, zero or more built-in methods, client interface mechanism, and one or more primary framework level objects 4000. The primary framework level 4000 differs from subsequently subsumed framework levels 4001 in that it is called directly from the framework instance object by the framework application and not through a subsumed static function 3002. It is responsible for initializing the framework engine 4200, processing command line options, and handling various exit scenarios. In one embodiment of the current invention, the exit scenario involves generating reports, logs, email and setting the exit value of the framework application 3000.

Evar engine 5002 provides the functionality needed to create and maintain one or more environment variables known as evars. Evars implement metadata that spans the entire automation environment and are implemented as objects that carry attributes defining their scope, value, instance mechanism indicator, and description of usage. As will be appreciated by those of skilled in the art, other information may be added to the evar class object to further refine their usage. Evars are either created internally by the framework engine 5000 or by functions 3002 subsumed into framework. Evars created by the framework are used to save framework specific state information. Evars created by subsumed methods may be used for any purpose but in one embodiment of the current invention are used to save use case state information. Since the scope of any given evar may span both child and sibling framework levels, those familiar with the art will recognize that evars can be used to implement use case scenarios that transcend the structural morphology of the framework.

In an embodiment of the current invention, an evars scope may be restricted to the current level and its' child framework levels 4001 or be global in scope available to any object in the framework application 3000 or to frameworks run on client systems 6000. Evars are made available to client systems 6000 by a mechanism whereby the list of currently exported evars is packaged by functionality in support 5001 into a protocol message and sent by the protocol engine 5004 to a remote client when a child framework application 3000 is started. There is no restriction on the value of an evar other than those imposed by the implementing language. To avoid problem with re-entrant code, evar engine 5002 uses an instance mechanism indicator set by the user to control whether or not values are saved by reference or by value.

Built-ins 5003 consist of zero or more class methods built into the framework engine 5000 that provide application specific support. They can be used in a supporting role in a manner similar to functionality in support 5001 or subsumed as a child level in the same manner as child framework level 4001. In one embodiment of the current invention, build-ins 5003 consists of spawning shell processes, inspecting the return code and output from spawned processes, displaying alerts, and putting up dialogues to ask for and receive input from the user.

Support 5001 provides a plurality of basic support functionality for system 100 that cut across other functionality it the framework engine. In one embodiment of the current invention, it provides support for logging debugging information to a trace file, exit control functionality that controls how and when a framework exits, timeout control that provides a generic mechanism for providing timeout control, and error message generation that processes language generated error messages into messages appropriate to the framework application.

Protocol engine 5004 provides bi-directional messaging support for system 100 between framework application processes 3000 running as clients and framework applications 3000 running as servers, as well as between servers 3000 and framework daemons 6001. The protocol engine 5004 implements a request-response protocol allowing parent processes to be tightly coupled to all phases of a client processes 6000. The protocol engine 5004 provides support for client processes running both synchronously and asynchronously using support mechanisms built into the support module 5001.

Primary framework level 4000 and child framework levels 4001 include a subsumption engine 4200, a reference redirection engine 4100, and zero or more child framework levels 4001. In one embodiment of the current invention, child framework levels 4001 exist as class objects until they are subsumed, at which time they are instantiated to become instance objects. Reference redirection engine 4100 redirects unresolved references to the subsumption engine 4200 in the primary framework level 4000 or a child framework level 4001. In one embodiment of the current invention, Python is the implementing language. Python provides a mechanism whereby the class method _getattr_( ) if defined by the script, is called with a reference identifier as the sole parameter when Python cannot resolve the reference. _getattr_( ) is written to call the reference redirection engine passing the parameter to it.

Reference redirection engine 4100 is the collection point for unresolved reference identifiers made in the context of the current framework level. Within system 100 a reference to a subsumable object comes in the form a path graph consisting of a plurality of vertices, where each vertex refers to a software entity, one or more of which may be unresolved. The start vertex is an instance object capable of subsumption and the terminal vertex is the software entity being subsumed. Internal vertices may also identify unresolved software entities that must be subsumed by subsumption engine 4200 to resolve their identity. Reference redirection 4100 culls references to internal objects and sends valid references identifiers to the subsumption engine 4200 for resolution.

Subsumption engine 4200 collects identifying information about static data, identifying information about static functions 3002 in the framework module 2000, identifying information about static functions 7101 in imported library modules 7100, identifying information about static data 7102 in external library modules 7100 as well as identifying imported module information needed to resolve references to library modules 7100. In one embodiment of the invention, the subsumption engine 4200 collects identifying information about evars and class objects as well.

Once subsumed, static functions 3002 as well as static functions 7101 in library modules 7100 become class methods 4003 of the primary framework level, 4000 or child framework level 4001, subsuming them. Once subsumed, class methods 4003 are indistinguishable from methods that are part of the original framework or child level classes objects. As such they can access built-in functionality 5001, evars defined by the evar engine, and support 5001 built into the framework engine 5000 in ways consistent with the implementing language without further modification. Built-in functionality 5001 can be anything needed by the framework application 3000 to accomplish its task. In one embodiment of this invention this includes support for email notification, remote script execution, logging, report generation and on-exit processing.

Client processes 6000 may run on the local host or on a remote computer system. Remote systems are initially configured with only a framework daemon 5000 and the runtime libraries needed to instantiate a framework engine 5000. A client on a remote system is populated with one or more framework modules 2000 and zero or more library modules 7100 when the framework application 3000, acting as a server, copies a framework module 2000, zero or more library modules 7100, and application specific data to the client 6000 through the client interface 1001 using built-in functionality 5001 to communicate with the framework daemon 6001 through a series of messages constructed and sent by protocol engine 5004. The framework engine 5000 on the host system 1000 requests the framework daemon 6001 to start the framework application process now residing on the remote system. A framework application 3000 residing on the remote client resolves references to both internal and external software entities in the same manner as a framework application 3000 running on a host system 1000. The framework engine 3000 running on client system 6000 communicates results back to the server 3000 through a set of protocol messages to be reported in a application specific way.

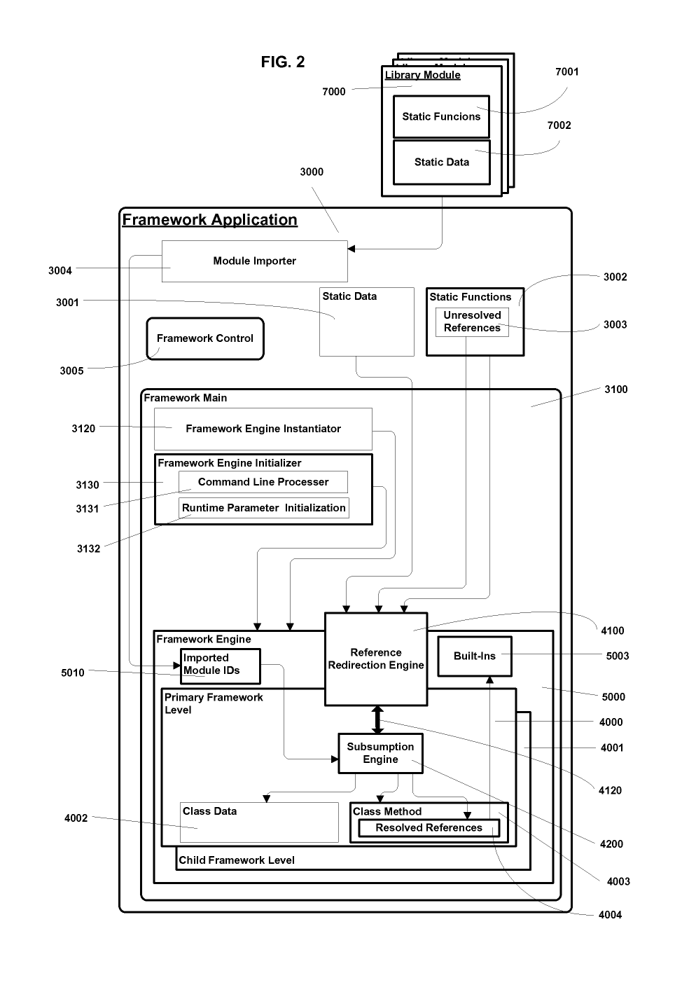

FIG. 2 provides a more detailed illustration of components of a framework application 3000 in accordance with an embodiment of the present invention.

Framework application 3000 includes an module importer section 3004, zero or more static data 3001, zero or more static functions 3002, framework control 3005, and framework main 3100.

Static functions 3002 include zero or more references 3003 to objects in the framework engine 5000 that are not resolvable until the function is subsumed. Unresolved references resolve to static functions 3002, static data 3001, child levels 4001, built-in functionality 5003, or imported modules 7000 in one embodiment of this invention.

Module importer 3004 imports zero or more user specified modules into the execution environment. Module identifying information is processed by the framework engine 5000 to create a list of imported module identifiers 5010.

Framework control objects 3005 are instantiated and used by system 100 to track entry to and exit from the primary framework level 4000 and one or more child framework levels 4001 in the framework application 3000.

Framework main 3100 includes framework engine instantiator 3120, framework engine initializer 3130, and framework engine 5000.

Framework engine instantiator 3120 instantiates a framework engine 5000 which establishes the primary framework level 4000. After the framework engine 5000 has been instantiated and the primary level 4000 established, in one embodiment of the invention, framework engine initializer 3130 invokes the command line processor 3131 to acquire command line parameters. Framework engine initializer 3130 then invokes runtime parameter initialization 3132 to set runtime state information. Command line and runtime state information are integrated into framework engine 5000 which is made available through evars to be used by primary framework level 4000.

Framework engine 5000 includes built-in functionality 5003, one or more primary framework level classes 4000 and zero or more child framework levels 4001. Both the primary framework level 4000 and child framework levels 4001 control what child framework levels 4001 may be subsumed in this way establishing a hierarchical ordering of framework levels. All framework levels present to the framework engine 2000 a reference redirection engine 4100 to intercept and redirect unresolved references to the current level.

The reference redirection engine 4100 is responsible for culling references to private objects in the framework engine instance object and passing 4120 all other references to the subsumption engine 4200 for resolution. References are passed to the reference redirection engine 4100 one at a time in the order in which they are encountered.

The subsumption engine 4200 only searches the module identified as the current module context in an effort to resolve unresolved references. The current module context is initially set to the main module and only switches to a library module when reference to it is subsumed by the framework engine 5000. A module context switch occurs when an unresolved reference is identified by the subsumption engine 4200 as a module id in the list of imported module IDs 5010. Once a module context switch occurs, references to data and function objects are now taken to be objects in the newly designated library module 7100. This does not preclude a module context switch to itself. In this fashion subsumption engine 4200 keeps track of what modules the currently executing function resides in.

Static functions are subsumed as class methods 4003 into the primary framework level 4000 or a child framework level 4001 when an unresolved reference 3003 in a subsumed function is identified by the subsumption engine 4200 as a static function in the current module context. Static data is subsumed into the primary framework level 4000 or child framework level 4001 as class data 4002 when a subsumed function 4003 makes a reference to static data identified by the subsumption engine 4200 as static data in the current module context. Data 7102 and functions 7101 in imported modules 7100 are subsumed into a framework level 4000 when the module context is set to be that of an imported library module 7100.

System 100 requires that static functions capable of being subsumed be written as if they are class methods 4003. Since subsumed functions are run as class methods of the subsuming objects parent class they have access to all the functionality built into the parent class object. In one embodiment of this invention, built-in functionality 5003 is defined in a base class and inherited by each framework level class object 4000 and 4001.

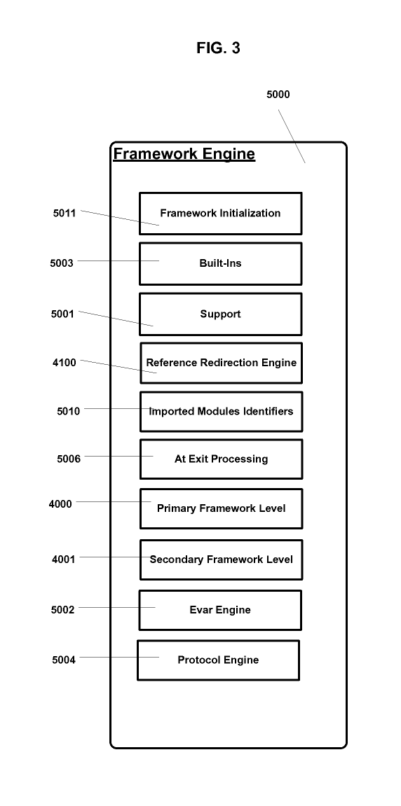

FIG. 3 provides a more detailed illustration of components in a framework engine 5000 in accordance with an embodiment of the present invention.

Framework engine 5000 includes a framework initialization mechanism 5011, built-in functionality 5003, support 5001 functionality, an at-exit processing mechanism 5006, one or more framework level 4000 class definitions, evar engine 5002, protocol engine 5004, and a list of imported module identifiers 5010.

The framework engine 5000 is the foundation on which an extensible automation framework 100 is build. The cross-cutting support functionality 5001 and built-ins functionality 5003 are inherited by all the framework levels 4000 defined in the framework engine 5000. This allows user provided functions 3002 and 7002 subsumed at runtime to have access to functionality that would be extremely difficult to provide otherwise. Logging as provided by one embodiment of the current invention is a good example. Instead of simply capturing messages output by a child script and logging them, messages output from subsumed functions 4003 are first cached to disk. Then, at report time, if logging has not been disabled, they are extracted, truncated as needed and output with surrounding contextual information as a text, xml, html, and csv report.

Framework initialization 5011 provides system 100 the means by which to configure the initial state of the framework engine before the primary framework level 4000 is entered. Initialization is done by using the evar engine 5002 to create a set of globally available environment variables used by the framework engine during the course of its operation. Initialization happens in three stages. In the first stage, initial values are assigned to the environment variables at compile time. In the second state, zero or more variables are created or updated based on environment information not available at compile time. Framework initialization 5011 is the third stage of initialization. It provides the user the opportunity to assign new values to zero or more environment variables at run time and have these values integrated into the framework engine 5000. Framework initialization 5011 in recalculates the values of existing environment variables that have a dependency on the reset variables.

Built-ins 5003 allows system 100 to provide the user with zero or more functionalities built into the framework engine 5000 at compile time. The functionalities are exposed as class data attributes and class methods of the current framework level. What differentiates built-ins 5003 from cross-cutting support 5001 functionality is that built-ins 5003 may be called as first level methods of a framework level. First level methods are, by definition, the first subsumed function in a chain of subsumed functions called by a framework level. Built-ins 5003 and any static function may be a first level function. First level functions may determine the state of the framework level 4000 on exit by returning the appropriate return code. Second level methods are methods subsumed within first level methods and subsequently subsumed methods. Values returned by second level methods are treated as data. Second level methods are referred to as ancillary functionality. The ability to subsume any function as either a first level method or as ancillary functionality allows system 100 to use the same function in multiple contexts for different purposes.

Support 5001 provides zero or more operations that are commonly used across the framework application. Methods exposed as support 5001 differs from methods exposed as built-ins 5003 in that they cannot be subsumed as a first level methods. Support functionality is framework level specific. A given support operation may or may not be implemented for all or even more than one given level. It may or may not work the same way in different framework levels. In one implementation of the current invention, support functionality 5001 includes logging, error message retrieval, status retrieval, setting on-exit functions, setting on-return functions, setting an on-email function, killing child processes, and starting a framework application on a remote client. Only one level had the ability to start a remote framework.

Reference redirection engine 4100 provides system 100 the opportunity to handle unresolved references to external software entities. It does so by intercepting unresolved references, analyzing them, and passing the valid references to the subsumption engine 4200 in the current framework. Invalid references are rejected and an error raised. The invalidity of any given reference is determined conventions established by the implementing language.

Imported module Identifiers 5010 is a list of modules imported into the current framework application. The list is similar to the list maintained by the implementing language except that it is global scope. Once a module is added, it is available till the framework terminates. This allows subsumed functions to reference libraries subsumed in other subsumed functions, without having to first import those modules in those libraries. Imported module identifiers 5010 is updated when modules are loaded using a support 5001 function for that purpose or when the subsumption engine 4200 identifies an unresolved reference as a reference to module in the list of imported modules maintained by the implementing language.

At-exit processing 5006 is a global mechanism for tracking what processing needs to be done when a subsumed function exits. At-exit processing 3006 uses framework control structures 3005 to track entry to and exit from first level methods. In this way system 100 allows each framework level to indicate level specific on-exit processing. In one embodiment of the current invention a single stack of exit functions is maintained for all instantiated levels. When a function is subsumed, an exit function is pushed onto the at-exit stack. Which function is pushed depends on which framework level is subsuming the function and the context in which the function is being subsumed. First level framework methods cause the framework engine to push the appropriate cleanup function onto the on-exit stack. When a first level method returns, the stack is popped and the function executed. If an error forces the code to skip the normal sequence of returns all functions on the at-exit stack between the current location on the stack and the end of the stack are popped and executed in turn.

Primary framework level 4000 is one or more class objects that define the primary (or first) framework level entered by the framework engine 5000. Entry into and exit from the primary framework level 4000 bounds and automation run. There may be zero or more automation runs executed by a framework application 3000. Framework application cleanup does not happen until the framework exits. In one embodiment the implementing languages exit processing is modified to call a function in the framework engine 5000 to generate and save automation run reports.

Secondary framework level 4001 is zero or more framework level class definitions. They may not be part of the framework application 3000 until such time as a subsumed method makes a reference to it. The current level module provides information to the subsumption engine 4200 so that only child framework levels that the current framework level supports may be subsumed. In this way a specific object model is defined and enforced by the framework engine 5000. The last child framework level in a chain of child framework levels that may be subsumed as defined by the frameworks object model as a terminal child framework level. Terminal child framework levels may only subsume methods as ancillary functionality.

Evar engine 5002 provides system 100 with the ability to extend the automation framework with information that cuts across subsumed functions and framework applications 3000 wherever run. Evars engine 5000 provides functionality to set variables with limited scope and export variables with global scope. Exported variables are visible to any framework level in an instance of a framework application 3000, visible to framework applications run as a client process either locally or remotely, and visible to child processes of the framework application process. Evars are a very important aspect of the current invention. They allow users to define use cases that span the natural morphology of the framework engine 5000 by describing meta information that is available to both child and sibling framework levels.

Protocol engine 5004 provides system 100 with the means to extend a framework application to remote processes, either locally or on a remote system. Protocol engine 5004 implements a bi-directional, connection oriented protocol engine with one or more message pairs consisting of a request and response message. In this way, system 100 can start, monitor, and control framework processes on remote systems. Since the protocols are synchronous in nature, it is relatively easy for system 100 to know exactly where and why a remote framework application failed should it indeed fail. Protocol engine 5004 implements send, receive, encode, decode and wait-for-message functionality.

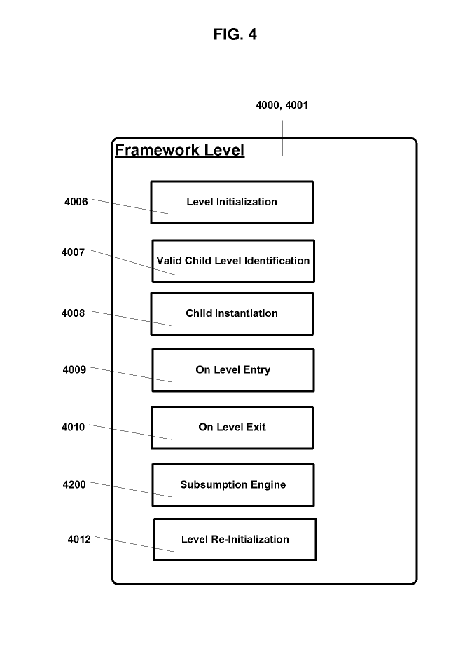

FIG. 4 provides a more detailed illustration of components in a primary framework level 4000 and child framework levels 4001 in accordance with an embodiment of the present invention. Both the primary framework level 4000 and child framework levels 4001 implement the same subsumption functionality.

Framework levels 4000, 4001 include a level initialization mechanism 4006, a valid child level identification mechanism 4007, one or more child instantiation mechanisms 4008, on level entry processing mechanism 4009, on level exit processing mechanism 4010, a subsumption engine 4200, and a level re-initialization mechanism 4012.

Level initialization 4006 is invoked when the framework is first instantiated to initialize the state of the object. The primary purpose of level initialization 4006 is to set attributes to recognizably initial values and to establish the appropriate links with support 5001, built-ins 5003, evar engine 5002, and protocol engine 5004 functionality.

Valid child level identification 4007 provides the means for the subsumption engine 4200 to determine if an unresolved reference identifies a valid child level.

Child instantiation engine 4008 is called by the subsumption engine 4200 to instantiate a child framework level object 4001 which assigns it to an attribute in the current framework level.

On level entry processing 4009 is used to create and save a context for the object being subsumed. It is this function that identifies the appropriate on level exit function and pushes it onto the at exit stack in framework control 3005. This function also tracks the current call chain and how deeply nested the current call is. In one embodiment of the current invention, the call chain is used for reporting results of the automation run and the nesting level is used to determine whether or not a static function is the on-entry function into a child level.

One or more on level exit 4010 processing mechanisms are defined to handle context specific exit situations. In one embodiment of the current invention, there are different on exit mechanisms for normal returns, returns cause by errors in the subsumed function, returns brought on by a failure state indication, and returns caused by the user requesting an early exit from the framework.

Subsumption engine 4200 is responsible for resolving references to subsumable objects visible within the scope of the automation framework application. In one embodiment of this invention this includes local static data and static functions, static data and static functions defined in external library modules, imported modules, child levels, class objects, and evars.

Level Re-initialization 4012 is used to re-initialize a child level upon re-entry by a subsumed function. In one embodiment of the current invention level re-initialization 4012 is used to reset selected attributes of a framework level to their initial values, in another embodiment, level re-initialization 4012 is used to delete and re-instantiate the child framework level object.

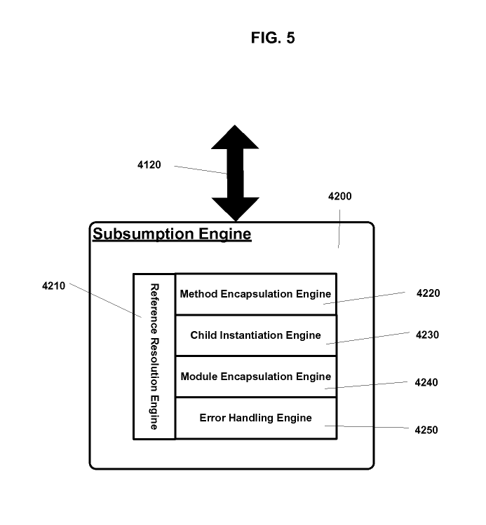

FIG. 5 provides a more detailed illustration of components in a subsumption engine level 4200 in accordance with an embodiment of the present invention.

Subsumption engine 4200 includes a reference resolution engine 4200, a method encapsulation engine 4220, a child instantiation engine 4230, a module encapsulation engine 4240, and an error handling engine 4250.

Reference resolution engine 4210 is used to resolve references passed 4120 to it from the reference redirection engine 4100. System 100 is extended by resolving references to software entities external to the automation framework. The framework application 3000 can only be extended with entities the reference resolution engine can resolve. In one embodiment of the current invention the reference resolution engine resolves references to static data and static functions in local module and imported modules, references to child framework levels, and references to imported modules. Once a reference is resolved and its type known, the resolved reference may be further processed as is the case for framework level references or passed back the subsuming object as in the case of static data.

Data references 3001 and 7001 are returned as class data attributes 4002. References that resolve to module names are passed to the module encapsulation engine 4220. References that resolve to valid child level identifiers are resolved by calling child instantiation engine 4230 which in turn calls child instantiation 4008 or level re-initialization 4012 to create the appropriate framework level instance. The error handling engine is called when a reference cannot be resolved to raise the appropriate language specific error. In one embodiment of the current invention, references to evars and aliases to module names are also resolved.

Method encapsulation engine 4220 is used to provide a context in which to execute static functions as class methods. For a static function to be subsumed, system 100 requires that the static functions be written in the manner of class methods. For example, Python class methods require that the first parameter to a class method be a reference to the parent class instance object. When method encapsulation engine 4220 receives a reference to a static function, the assumption is that the first parameter in the static function definition is a reference to a parent class instance object. In this manner, static functions can be written with references to attributes in the parent class with the knowledge that these attributes will be available at run time.

It is important to note that the method encapsulation engine 4220 provides the framework engine 5000 the opportunity to extend the framework application by extracting information about parameters being passed to the function. In one embodiment of the current invention, subsumed static functions are assumed to define a timeout, description, and logging control argument. If a function is defined without one or more of these arguments and the call to the subsumed method pass in one or more of them, the method encapsulation engine 4220 removes the missing arguments from the function call while at the same time saving the values defined by these arguments to be used later by the framework engine 5000. For example, a call is made to a function wherein a timeout is specified as a parameter to the subsumed function but the function definition does not define a timeout argument. Normally this would result in an error. But the method encapsulation engine 4220, anticipating a timeout argument, removes the timeout argument from the arguments being passed to the function and invokes it. It invokes it in a manner which limits the length of time the function can execute to the value associated with the timeout value originally specified

Method encapsulation engine 4220 also controls execution context by passing a reference to the resolved method to a function in the current framework level designed to execute first level methods. In this way, first level methods are wrapped in code that provides the appropriate on-entry and on-exit functionality. In one embodiment of the current invention, the framework level logs information about the current framework level on-entry into that level, calls the first level method, executes an on-return function if one has been specified by the user, and finally logs an on-exit message summarizing the functionality executed while in the child level.

Method encapsulation engine 4220 is also able to determine when a function 3002 is being subsumed by a function already subsumed that is being subsumed as ancillary functionality. All ancillary functions have as their parent class instance the class instance of the subsuming level. As such, ancillary functions act as extensions to the first function subsumed, regardless of how deep the call chain is. All ancillary functions have access to all the same support 5001 and built-ins 5003 as the first function subsumed. The only difference between the first level methods and ancillary methods is the context in which they execute. Because all subsumed functions act as class methods of the subsuming framework level regardless of how deep the call chain is, static functions 7101 may be added to library modules 7100 without regard to which framework level they will eventually execute in. Not only does this allow any given framework application 3000 to be easily extended, libraries are also easily extended simply by adding additional autonomous functions to them.

Child instantiation engine 4230 is responsible for instantiating a child framework level 4001 if one does not exist or re-initializing a level if one is already associated with the current level. If a child framework level does not exist, a framework level instantiation routine in the current level is called to instantiate a new framework level. In one embodiment of the current invention, level objects are reused, not freed and re-instantiated.

Module encapsulation engine 4240 is responsible for setting the current module context for the framework engine 5000 to the imported module named by the reference. Once the context has changed from one module to another, subsequent method and data references must be to static data and static functions in the current module. This remains so until the context once again changes by either descending to a new child level or returning to the previous level.

Error handling engine 4250 is responsible for constructing an appropriate error message and raising an “attribute unresolved error” when a reference cannot be resolved.

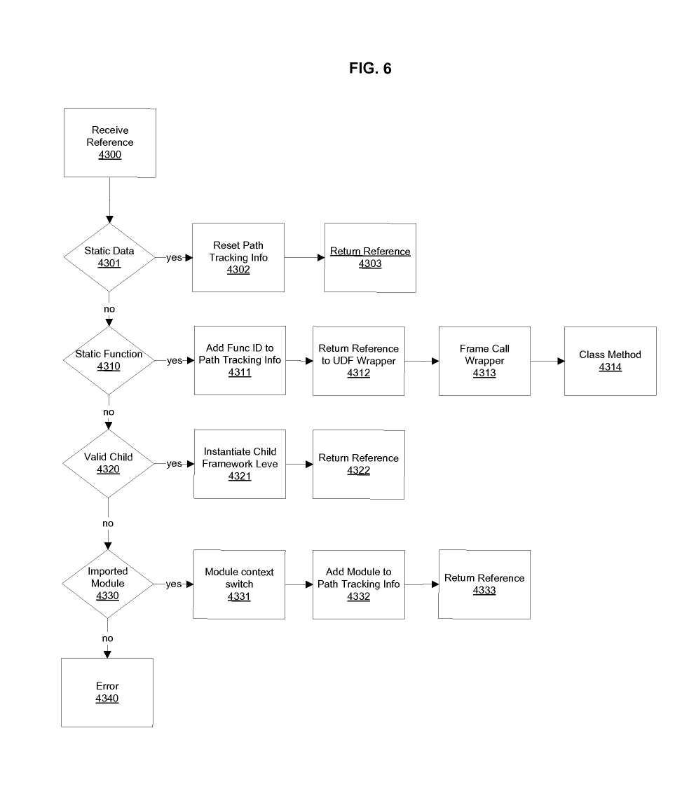

FIG. 6 provides an operational flow of the subsumption process of system 100 in accordance with an embodiment of the present invention.

As a prelude to understanding the subsumption process of system 100 keep in mind the following. Subsumption engine 4200 maintains tracking information on a per framework level basis and maintains a sequence of subsumed software entities. This provides context information that a framework level can use in determining what is a valid subsumable object and into what context it can be subsumed. Additionally, tracking information is also used to restore the correct module context on return from a subsumed object. Initially, the tracking information indicates no subsumed objects. As objects are subsumed, tracking information is updated and the framework level context changes accordingly. Note: Tracking information is not used to track framework level context which is maintained by the framework level. Also note that the framework level context is not the same as the module context. Module context is the means that the subsumption engine uses to allow users of system 100 to subsume software entities from different modules. System 100 also maintains a call chain. A call chain is the series of references starting with the first level method culminating with the current reference. In one embodiment of the current invention, a call chain is represented series of dot-delimited reference identifiers.

Subsumption engine receives an unresolved reference 4300. In one embodiment of the current invention, the unresolved reference may be a reference to static data, a static function, a child framework, or to an imported module. As will be appreciated by those of skill in the art, additional reference types may be handled by adding the appropriate selection criteria and resolution mechanism to the subsumption engine. In one embodiment of the current invention, the subsumption engine is used to resolve references to evars, class objects and function references. Initially the main module will be the focus of the module context, the call chain will have zero elements in it and the index into the call chain will be zero.

If the reference resolves to static data 4301 in the current module context, path tracking information is reset 4302, and a reference to the resolved data object is returned 4303.

If the reference resolves to a static function 4310, the resolved object is added to the path tracking information 4311 in the current framework level object. Then a reference to a method used to wrap the user define function UDF Wrapper 4312 is returned. This results in the UDF Wrapper 4312 method being called. UDF Wrapper 4312 methods collects and saves information from the tracking information current framework level, and calls the call wrapper method 4313 defined in the current framework level object. Call wrapper 4313 uses the information extracted from the path tracking information and does any framework level specific on-entry processing associated with the subsuming framework level, saves framework level state information, increments the framework level index, adjusts function parameters as needed, and calls the static function as a class method 4314. On return from the subsumed method, the framework level executes any framework specific on-exit processing, updates state information in the parent framework level and adjusts the module context to the context associated with the currently subsumed function. On return from a first level function, the module context is changed to the parent module.

If the reference resolves to a valid child framework level 4320, the level is instantiated or re-initialized 4321 and the child object level returned 4322.

If the reference resolves to an imported module 4330 the subsumption engine does a module context switch 4331 to the new module. The module reference is added o the path tracking information 4332 and a reference to the subsumed module is returned 4333.

If the reference has not been resolved to static data, a static function, a child framework level or an imported module, an error is raised 4340.

Note that while the above description uses terms such as “static functions”, “instance objects”, and “class methods” it is not intended to limit the described invention to language environments that use these labels. Rather these labels are used to describe entities with similar functionality in any language environment.

Further, although the present invention has been described using the term “extensible automation framework for device testing”, it can also be applied to solving extensibility issues of other software applications where there is the desire to be able to extend the application in a simple and straight forward manner in such a way that does not require defining new classes. This would include such applications as scripting tools, GUI driven front end software, protocol driven control software, and other instances where there is the need to accesses device interface functionality in flexible hierarchical fashion.

Further it should be noted that the term “use case” describes the task being automated not a component of a system in accordance with the current invention.

The present invention has been describe in particular detail with respect to a limited number of embodiments. Those of skill in the art will appreciate that the invention may additionally be practiced in other embodiments. First, the particular naming of the components, capitalization of terms, the attribute, data structures, or any other programming or structural aspect is not mandatory or significant, and the mechanisms that implement the invention or its features may have different names, formats or protocols. Further, the system may be implemented entirely in software as described, or entirely in hardware or a combination of hardware and software. Also, the particular division of functionality between the various system components described herein is merely exemplary, and not mandatory; functions performed by a single system component may instead be performed by multiple components, and functions performed by multiple components may instead be performed a single component. For example, in an alternative embodiments, Static data 3001 and static functions 3002 exist solely within framework application 3000; Framework engine 5000 consists of one framework level; and the like.

Unless specifically stated otherwise as apparent from the present discussion, it is appreciated that throughout the description, discussions utilizing terms such as “processing” or “computing” or “calculating” or “determining” or “displaying” or the like, refer to similar action or process of a computer system or similar electronic computing device. that manipulates and transforms data represented as physical (electronic) quantities within the computer system memories or registers or other such information storage, transmission or display devices.

The present invention also relates to an apparatus for performing the operations herein. The apparatus may be specifically constructed for the required purposes, or it may comprise a general-purpose computer selectively activated or reconfigured by a computer program stored in the computer. Such a computer program may be store in a computer readable storage medium, such as, but is not limited to, any type of disk including floppy disks, optical disks, CD-ROMs, random access memories (RAMs), EPROMs, EEPROMS, magnetic or optical cards, application specific integrated circuits (ASICs), or any type of media suitable for storing electronic instructions, and each coupled to a computer system bus. Furthermore, the computers referred to in the specification may include single processor or may be architectures employing multiple processor designs for increased computing capability.

The algorithms presented herein are not inherently related to any particular computer or any apparatus, various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any such references to specific languages are provided for the disclosure of enablement and the best mode of the present invention.

The figures depict preferred embodiments of the present invention for the purposes of illustration only. One skilled in the art will readily recognize from the following discussion that alternative embodiments of the structures and methods illustrated herein may be employed without departing from the principles of the invention described herein.

Finally, it should be noted that the language use in the specification has been principally selected for readability and instructional purposes, and may not have been selected to delineate or circumscribe the inventive subject matter. Accordingly, the disclosure of the present invention is intended to be illustrative, but not limiting, of the scope of the invention.

I claim:

1. A computer-implemented method for extending an automation framework the method comprising:
receiving a plurality of unresolved references to software entities outside the scope of the framework application;
resolving each unresolved reference in turn to a specific software entity;
processing resolved references that operate in a context specific manner;
creating a global context that spans the automation framework environment; and
extending the automation framework by operating on resolved software entities as members of the referencing object.

2. The method of claim 1 wherein receiving a plurality of unresolved references to software entities outside the scope of the framework application further comprises:
intercepting a plurality of unresolved references as a path graph referring to a software entity is sequentially parsed;
rejecting unresolved references that are identified by inspection as being un-resolvable; and
passing to the name resolution engine said unresolved reference names not rejected.

3. The method of claim 1 resolving each unresolved reference in turn to a specific software entity further comprises:
receiving the name of an unresolved reference;
identifying said unresolved reference as the name of a software entity external to the automation framework; and
wherein said software entity may be an un-instantiated child framework level, the name of an imported module, or the name of a software entity in the current module context.

4. The method of claim 1 processing resolved references that operate in a context specific manner further comprises:
creating an instance object of a valid child framework level when the unresolved reference identifies a valid child framework level class object in the current framework level context;
changing the current module context to specify a module object identified by said unresolved references;
executing static functions as class methods in a context determined by the current state of the framework application; and
changing the current state of the framework application as a function of said processed reference.

5. The method of claim 1 creating a global context that spans the automation framework environment further comprises:
defining a plurality of metadata objects that contain a plurality of state information and data objects; and
scoping said metadata objects with a plurality of scoping levels depending on need.

6. The method of claim 1 extending the automation framework by operating on resolved software entities as members of the referencing object further comprises:
receiving a plurality of resolved references;
operating on the resolved references in a context specific determined by correlating the type of the resolved reference, the current state of the framework application and globally available metadata; and
extending the framework application with software entities defined in library modules, running on local and remote clients.

7. A system for extending an automation framework, comprising;
a plurality of software entities defined inside and outside the automation framework, each entity defined in a software module known to the automation framework engine;
a reference redirection mechanism that intercepts unresolved references to a plurality of software entities outside the automation framework and redirects processing to a reference resolution mechanism;
a reference resolution mechanism that resolves said reference to a software entity outside the framework or to a valid child level not yet instantiated.
a level instantiation mechanism that calls a factory method defined in the current framework level to instantiate a child framework level object thus resolving the reference to it.
a module resolution mechanism that resolves references to external modules and sets the current module context;
an attribute resolution mechanism that resolves references to attributes in the static name space of modules in the current module context;
a function resolution mechanism that resolves references to functions in the static name space of modules known to the framework engine;
an encapsulation mechanism defined in the current level to call static functions as class methods in a context consistent with the current state of the organizational level subsuming the function;
an evar engine used both internally and by a user to define and maintain a plurality global framework metadata objects; and
a protocol engine to pass a plurality of state information, data, libraries, and framework applications to a remote host for execution.

8. A computer program product for an extensible automation framework, the computer program product stored on a computer readable medium and configured to cause a computer process to execute the steps of:
receiving a plurality of unresolved references to software entities outside the scope of the framework application;
resolving each unresolved reference in turn to a specific software entity;
processing resolved references that operate in a context specific manner;
creating a global context that spans the automation framework environment; and
extending the framework by incorporating the resolved software entities in such a manner as they operate as members of the referencing object.

9. The computer program product of claim 8 wherein receiving a plurality of unresolved references to software entities outside the scope of the framework application further comprises:
intercepting a plurality of unresolved references as a path graph referring to a software entity is sequentially parsed.
rejecting said unresolved references that are identified by inspection as being un-resolvable; and
passing to the name resolution engine said unresolved reference names not rejected.

10. The computer program product of claim 8 resolving each unresolved reference in turn to a specific software entity further comprises:
receiving the name of an unresolved reference;
identifying said unresolved reference as the name of an software entity external to the automation framework; and
wherein said software entity may be an un-instantiated child framework level, the name of an imported module, or the name of a software entity in the current module context.

11. The computer program product of claim 8 processing resolved references that operate in a context specific manner further comprises:
creating an instance object of a valid child framework level when the unresolved reference identifies a valid child framework level class object in the current framework level context;
changing the current module context to specify a module object identified by said unresolved references;
executing static functions as class methods in a context determined by the current state of the framework application; and
changing the current state of the framework application as a function of said processed reference.

12. The computer program product of claim 8 creating a global context that spans the automation framework environment further comprises:
defining a plurality of metadata objects that contain a plurality of state information and data objects; and
scoping said metadata objects with a plurality of scoping levels depending on need.

13. The computer program product of claim 8 extending the automation framework by operating on resolved software entities as members of the referencing object further comprises:
receiving a plurality of resolved references;
operating on the resolved references in a context specific determined by correlating the type of the resolved reference, the current state of the framework application and globally available metadata; and
extending the framework application with software entities defined in library modules, running on local and remote clients.
